(19) United States
(12) Patent Application Publication
(10) Pub. No.: US 2026/0116147 A1
(43) Pub. Date: Apr. 30, 2026

(54) INDOOR CONDITION CONTROL SYSTEM FOR VEHICLE

(71) Applicant: TOYOTA JIDOSHA KABUSHIKI KAISHA, Toyota-shi (JP)

(72) Inventor: Eiichi Hioka, Toyota-shi (JP)

(73) Assignee: TOYOTA JIDOSHA KABUSHIKI KAISHA, Toyota-shi (JP)

(21) Appl. No.: 19/367,983

(22) Filed: Oct. 24, 2025

(30) Foreign Application Priority Data
Oct. 30, 2024 (JP) 2024-190272

(51) Int. Cl. B60H 1/00

(52) U.S. Cl. CPC B60H 1/0073; B60H 1/00821

(57) ABSTRACT

An indoor condition control system for vehicle configured to allow a driver to enjoy a sensation of driving regardless of traveling environment. The indoor condition control system is applied to a vehicle comprising a side window and a blower. The indoor condition control system comprises: a travel determiner configured to determine that the vehicle is in travel, an opening degree determiner configured to determine an opening degree of the side window, and an airstream controller configured to control an airstream emitted toward a driver during propulsion of the vehicle when the opening degree of the side window is narrower than a predetermined degree.

### CROSS-REFERENCE TO RELATED APPLICATIONS

The present disclosure claims the benefit of Japanese Patent Application No. 2024-190272 filed on October 30, 2024 with the Japanese Patent Office, the disclosures of which are incorporated herein by reference in its entirety.

### BACKGROUND

### Field of the Disclosure

The embodiment of the present disclosure relates to the art of a system for controlling conditions in a vehicle compartment, and more particularly, to a system for controlling an airflow in the vehicle compartment.

### Discussion of the Related Art

Vehicles are not only used for a transportation purpose but also driven for pleasure e.g., in motor sports. The driving pleasure is derived from a driving performance, a running stability, a quietness, a habitability, a diversity of functions etc. of the vehicle. For example, JP-A-2015-228257 discloses a driving support device configured to open and close windows for the purpose of driving assistance. In a basic way, the vehicle window is opened to ventilate the passenger compartment and closed to block a rainwater and an external air from entering the passenger compartment. Whereas, the driving support device described in JP-A-2015-228257 is configured to use windows of the vehicle to notify a driver of an approach of other vehicles from behind. Specifically, the driving support device described in JP-A-2015-228257 is configured to notify the driver of the approach of other vehicles by changing a condition of the window. In addition, the driving support device described in JP-A-2015-228257 is further configured to reduce an opening degree of the windows as the rainfall increases.

In addition to ventilating the passenger compartment and assisting the driver in operating the vehicle as described in JP-A-2015-228257, the windows of vehicles may be opened to allow the driver to feel the wind while driving as in a convertible car. However, as described in JP-A-2015-228257, the window must be closed or the opening degree of the window must be reduced in the event of rainfall. Likewise, the window must be closed when a bad odor derived from e.g., an exhaust gas leaks into the passenger compartment, or when the vehicle travels in an environment where dust is flying around. Thus, the conventional driving support devices have to be improved so as to allow the driver to feel the wind for pleasure regardless of traveling environment.

### SUMMARY

The embodiment of the present disclosure has been conceived noting the foregoing technical problems, and it is therefore an object of the present disclosure to provide an indoor condition control system for vehicle configured to allow a driver to enjoy a sensation of driving regardless of traveling environment.

According to the exemplary embodiment the present disclosure, there is provided an indoor condition control system for a vehicle, comprising: a partition member partitioning a vehicle compartment and an external space; a blower that emits an airstream toward a driver seated in the vehicle compartment; and a controller that controls a volume of the airstream emitted toward the driver by the blower. In order to achieve the above-explained objective, according to the exemplary embodiment of the present disclosure, the controller comprises: a travel determiner configured to determine that the vehicle is in travel; an opening degree determiner configured to determine that an opening degree of the partition member is equal to or narrower than a predetermined degree; and an airstream controller configured to control the airstream emitted toward the driver upon satisfaction of a predetermined condition including a fact that the travel determiner determines that the vehicle is in travel, and a fact that the opening degree determiner determines that the opening degree of the partition member is equal to or narrower than the predetermined degree.

In a non-limiting embodiment, the travel determiner may include a vehicle speed detector configured to detect a speed of the vehicle, and the airstream controller includes an air volume controller configured to increase an air volume of the airstream emitted toward the driver in accordance with the speed of the vehicle detected by the vehicle speed detector.

In a non-limiting embodiment, the indoor condition control system may further comprise an airstream selector that is operated by the driver to select an airstream mode in which the airstream is emitted toward the driver by the airstream controller.

In a non-limiting embodiment, the blower may include an air conditioner that controls a temperature in the vehicle compartment by sending the air into the vehicle compartment, and the airstream controller is further configured to emit the airstream toward the driver by the air conditioner when the airstream selector is operated by the driver.

In a non-limiting embodiment, the vehicle may comprise a motor that serves as a prime mover, and an electric storage device that supplies an electric power to the blower and the motor. In addition, the controller may further comprise: a state of charge level detector configured to detect that a current state of charge level of the electric storage device is equal to or lower than a predetermined level; and an airstream inhibitor configured to inhibit the emission of the airstream by the airstream controller when the state of charge level of the electric storage device is equal to or lower than the predetermined level.

In a non-limiting embodiment, the vehicle may comprise a simulated sound emitter that emits a simulated sound in accordance with the airstream emitted into the vehicle compartment by the airstream controller.

Thus, according to the exemplary embodiment of the present disclosure, the air is sent to the driver in a situation where a side window or a convertible roof has to be closed and the wind may not be introduced into the vehicle compartment. According to the exemplary embodiment of the present disclosure, therefore, the driver is allowed to virtually feel the wind even when the vehicle travels in the rain or travels through a site where dust is flying. Since the driver is thus allowed to feel the driving pleasure, an additional value of the vehicle may be increased.

In addition, the driver is allowed to feel the speed of the vehicle more realistically by increasing an air volume of the airstream in accordance with an increase in the speed of the vehicle.

Moreover, the airstream may be created only by the existing air conditioner without requiring extra equipment or components.

Further, since the airstream is created only in the condition where a state of charge level of the electric storage device is higher than the predetermined level, the vehicle is allowed to travel without problem.

Furthermore, the driver is allowed to feel the speed of the vehicle more realistically by emitting the simulated sound together with emitting the airstream.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a schematic illustration showing a structure of a vehicle to which the control system according to the exemplary embodiment of the present disclosure is applied;

FIG. 2 is a schematic illustration showing a structure of an air-conditioning system according to the exemplary embodiment of the present disclosure;

FIG. 3 is a block diagram showing functions of a controller according to the exemplary embodiment of the present disclosure; and

FIG. 4 is a flowchart showing one example of a routine executed by the controller.

### DETAILED DESCRIPTION OF THE PREFERRED EMBODIMENTS

An embodiment of the present disclosure will now be explained with reference to the accompanying drawings. Note that the embodiments shown below are merely examples of the present disclosure, and do not limit the present disclosure.

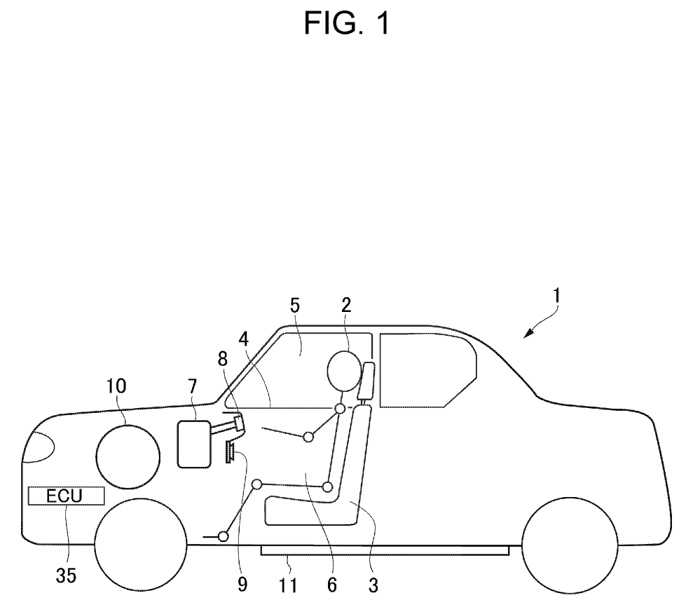

Referring now to FIG. 1, there is shown one example of a structure of a vehicle 1 to which the control system according to the exemplary embodiment of the present disclosure is applied. As illustrated in FIG. 1, the vehicle 1 is an ordinary passenger car operated by a driver 2 seated on a driver seat 3. The driver 2 gets into the vehicle 1 and gets out of the vehicle 1 through a front door 4. The front door 4 is provided with a side window (or window glass) 5 as a partition member of the exemplary embodiment of the present disclosure, and the side window 5 is opened and closed by operating a switch or a lever. In order to condition an air and a temperature in a vehicle compartment 6, the vehicle 1 is provided with an air conditioner (or air conditioning system) 7 serving as a blower of the exemplary embodiment of the present disclosure. As described later, the air conditioner 7 includes an air outlet 8 that sends air toward the driver 2.

A speaker 9 serving as a simulated sound emitter of the exemplary embodiment of the present disclosure is arranged in the vehicle compartment 6. For example, a speaker of an audio system (not shown), a dedicated speaker, or an oscillator for emitting a sound in opposite phase to that of the environmental noise (background noise) to silence the vehicle compartment 6 may be adopted as the speaker 9.

The vehicle 1 shown in FIG. 1 is an electric vehicle having a motor 10 as a prime mover. Accordingly, the vehicle 1 includes an electric vehicle (BEV) in which only the motor 10 serves as a prime mover, and a hybrid vehicle (HEV, PHEV) in which a prime mover includes the motor 10 and an engine (not shown). Therefore, the vehicle 1 comprises an electric storage device (e.g., a secondary battery) 11 that stores an electric power to be supplied to the motor 10 and the air conditioner 7.

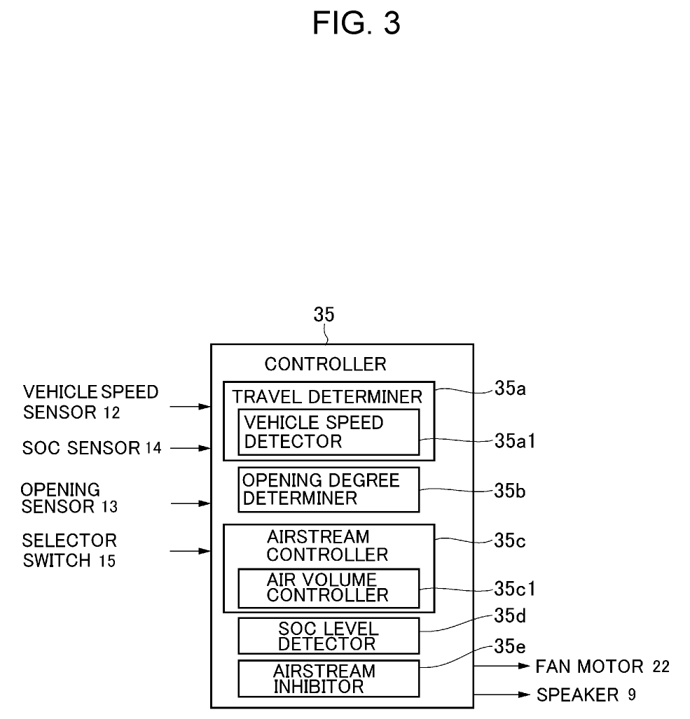

The vehicle 1 further comprises various sensors for collecting data to execute an after-mentioned routine. As shown in FIG. 3, the sensors include a vehicle speed sensor 12 that detects a speed of the vehicle 1, an opening sensor 13 that detects an opening degree of the side window 5, and an SOC sensor 14 that detects a state of charge (abbreviated as SOC hereinafter) level of the electric storage device 11. In addition, a selector switch 15 for selecting an airstream mode is arranged in the vehicle 1. For example, these sensors and switch may be arranged in a dashboard. Details of these sensors and switches will be described later.

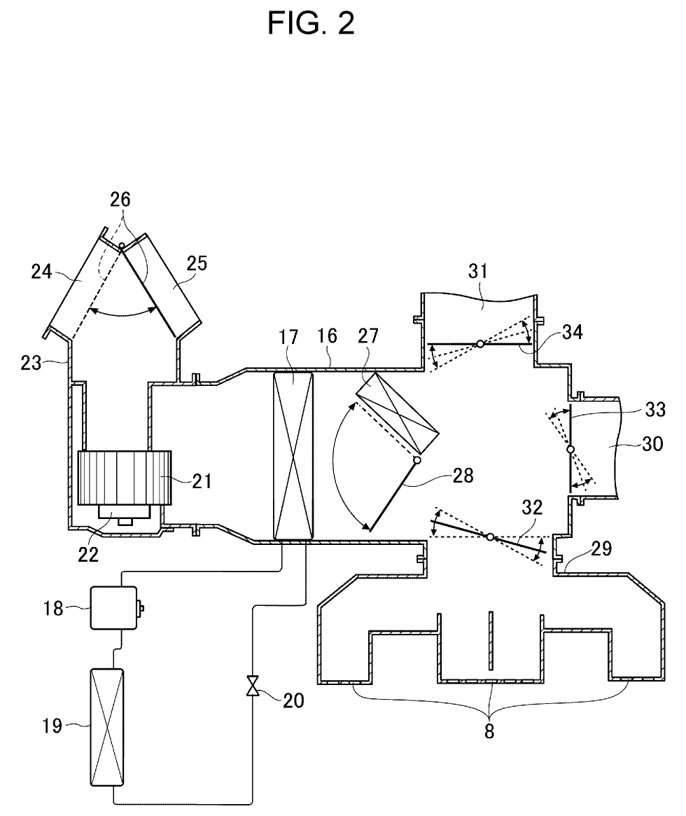

Here will be explained an example of the air conditioner 7 with reference to FIG. 2. Fundamental structures of the air conditioner 7 are similar to those of conventional air conditioners mounted on vehicles. The air conditioner 7 is housed in a housing space formed in a front section of the vehicle 1 where the motor 10 is housed. As illustrated in FIG. 2, the air conditioner 7 comprises a casing 16, and the air flows through the casing 16. A heat exchanger 17 as an evaporator employed in a compression refrigeration cycle is disposed in the casing 16, and the heat exchanger 17 is connected to an inlet side of the compressor 18. An outlet side of the compressor 18 is connected to a condenser 19, and the condenser 19 is connected to the heat exchanger 17 through an expansion valve 20. In the air conditioner 7, a refrigerant is evaporated as a result of cooling the air in the heat exchanger 17, and the evaporated refrigerant is pressurized and compressed by the compressor 18. Thereafter, the compressed refrigerant is liquefied as a result of radiating heat in the condenser 19, and a temperature of the refrigerant is lowered by an adiabatic expansion caused in the expansion valve 20. The refrigerant whose temperature has thus lowered flows into the heat exchanger 17.

A blower fan 21 is disposed upstream of the heat exchanger 17. For example, a sirocco fan may be employed as the blower fan 21. The blower fan 21 is rotated by the fan motor 22 to introduce air, and blows the air toward the heat exchanger 17. Specifically, a unit of the blower fan 21 and the fan motor 22 is housed in an introduction case 23 joined to the casing 16. The introduction case 23 comprises an external air inlet port 24 opening toward outside, and an internal air inlet port 25 opening toward the vehicle compartment 6. The external air inlet port 24 and the internal air inlet port 25 are selectively opened and closed by actuating the switching door 26 by a motor (not shown).

A heater core 27 as a heat exchanger for heating is arranged downstream of the heat exchanger 17. Given that the vehicle 1 is an electric vehicle, an electric heater is adopted as the heater core 27. Whereas, given that the vehicle 1 is a hybrid vehicle having an engine, a heat exchanger that heats the air by an engine coolant is adopted as the heater core 27. An amount of the air passing through the heater core 27 is controlled by a mixing door 28 actuated by a motor (not shown).

Ducts 29, 30, and 31 are joined to an end portion of the casing 16 of downstream of the heater core 27. The first duct 29 is adapted to deliver the air to the air outlet 8, and is opened and closed by a switching door 32 actuated by a motor (not shown). The second duct 30 is adapted to direct the air to feet and legs of the driver 2, and is opened and closed by a switching door 33 actuated by a motor (not shown). The third duct 31 is adapted to deliver the air to a defroster, and is opened and closed by actuating a switching door 34 by a motor (not shown).

The control system according to the exemplary embodiment of present disclosure is configured to create a simulated airstream (or simulated wind) in the vehicle compartment 6 while the vehicle 1 is traveling. To this end, control system according to the exemplary embodiment of present disclosure is provided with a controller 35 shown in FIG. 3. Specifically, the controller 35 is an electronic control unit (abbreviated as ECU in FIG. 1) comprising a microcomputer including a central processing unit (CPU), a storage element (RAM, ROM), an interface, and so on. The controller 35 is configured to perform calculation using a predetermined program based on incident data and data stored in advance, and transmits a calculation result in the form of control signal. In order to create the simulated airstream, for example, the controller 35 collects data about a speed V of the vehicle 1 detected by the vehicle speed sensor 12, an opening degree of the side window 5 detected by the opening sensor 13, and an SOC level of the electric storage device 11 detected by the SOC sensor 14. In addition, a signal for selecting the airstream mode to create the simulated airstream is transmitted to the controller 35 from the selector switch 15 as an airstream selector of the exemplary embodiment of the present disclosure.

In order to create the simulated airstream, a predetermined speed as a reference value of the vehicle speed V, a predetermined opening degree as a reference value of an opening degree of the side window 5 for determining whether the side window 5 is opened or closed, a predetermined level as a reference value of an SOC level of the electric storage device 11 etc., are stored in the controller 35 in advance. For example, the controller 35 transmits a command signal for controlling a rotational speed of the blower fan 21 or the fan motor 22, a command signal for emitting a simulated wind sound from the speaker 9.

As shown in FIG. 3, the controller 35 comprises a travel determiner 35a, an opening degree determiner 35b, an airstream controller 35c, an SOC level detector 35d, and an airstream inhibitor 35e. The travel determiner 35a is configured to determine that the vehicle 1 is traveling. Specifically, the travel determiner 35a determines that the vehicle 1 is in travel if the vehicle speed V is equal to or higher than the predetermined speed. To this end, the travel determiner 35a includes a vehicle speed detector 35a1. The opening degree determiner 35b is configured to determine that the opening degree of the side window 5 is equal to or narrower than the predetermined degree. For this purpose, the predetermined opening degree is set to a small value, e.g., to substantially "0". That is, the opening degree determiner 35b is configured to determine that the side window 5 is closed.

The airstream controller 35c is configured to emit the simulated airstream toward the driver 2 in a situation where a speed of the vehicle 1 is equal to or higher than the predetermined speed, and an opening degree of the side window 5 is equal to or narrower than the predetermined degree. Specifically, the airstream controller 35c executes and terminates the emission of the simulated airstream, and adjusts the air volume of the simulated airstream. For these purposes, the airstream controller 35c includes an air volume controller 35c1. In addition, the airstream controller 35c transmits a command signal for emitting the simulated wind sound from the speaker 9 in accordance with an amount of the air volume of the simulated airstream. As an option, the airstream controller 35c may be further configured to adjust an opening degree and an orientation of the air outlet 8 according to the situation. In addition, the airstream controller 35c may be further configured to send the simulated airstream while giving off an aroma according to circumstances. To this end, the simulated airstream may be mixed with e.g., an ozone. For example, when the vehicle 1 travels along the coast, salty aroma may be mixed into the simulated airstream.

The SOC level detector 35d is configured to determine that a current SOC level of the electric storage device 11 is equal to or lower than the predetermined level based on an SOC level transmitted from SOC sensor 14. The airstream inhibitor 35e inhibits the emission of the simulated airstream when the SOC level of the electric storage device 11 is equal to or lower than the predetermined level.

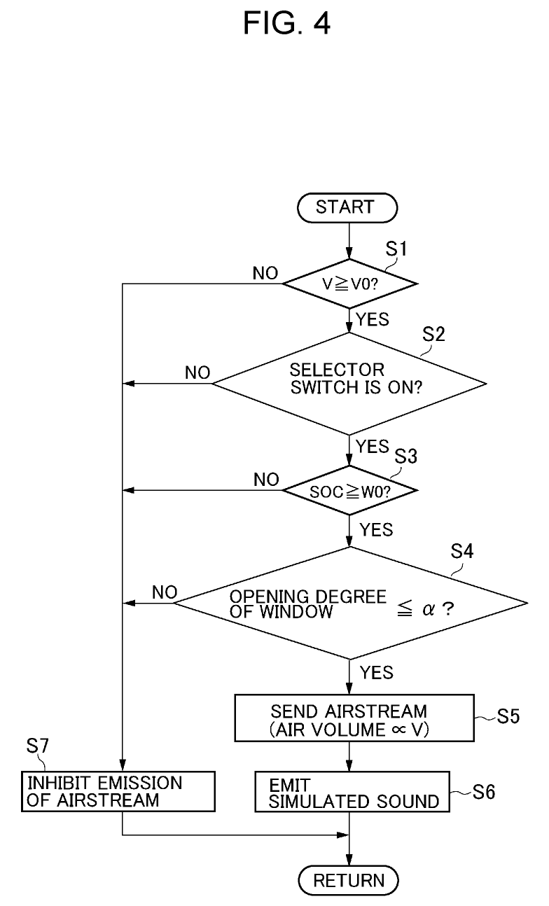

An example of a routine executed by the controller 35 is shown in FIG. 4. The routine shown in FIG. 4 is executed repeatedly at predetermined short time intervals as long as a ready switch (not shown) of the vehicle 1 is ON. At step S1, the controller 35 determines whether the vehicle speed V is equal to or higher than the predetermined speed V0. If the vehicle speed V is equal to or higher than the predetermined speed V0 so that the answer of the step S1 is YES, the routine progresses to step S2 to determine whether the selector switch 15 is ON. As described above, the simulated airstream is emitted by turning on the selector switch 15 in accordance with a speed of the vehicle 1 and an opening degree of the side window 5. For example, the selector switch 15 is arranged in an instrument panel (not shown) so that selector switch 15 is operated by the driver 2. Otherwise, the selector switch 15 may also be displayed in a touch panel (not shown) in the form of a touch button.

If the selector switch 15 is ON so that the answer of step S2 is YES, the routine progresses to step S3 to determine whether an SOC level of the electric storage device 11 is equal to or higher than the predetermined level W0. According to the exemplary embodiment of the present disclosure, the predetermined level W0 is set to a level that does not hinder the propulsion of the vehicle 1 and the execution of the related control.

If the SOC level of the electric storage device 11 is equal to or higher than the predetermined level W0 so that the answer of step S3 is YES, the routine progresses to step S4 to determine whether an opening degree of the side window 5 is equal to or narrower than the predetermined degree α. The control system according to the exemplary embodiment of the present disclosure is configured to emit the simulated airstream into the vehicle compartment 6 in the situation where the driver 2 is not allowed to feel the wind during propulsion of the vehicle 1. Therefore, the opening degree α as a criterion for determining the opening degree of the side window 5 is set to a degree at which the wind does not enter the vehicle compartment 6 or the driver 2 is not allowed to feel the wind entering the vehicle compartment 6 during propulsion, based on a result of an experiment or a simulation. Note that the order to execute the determinations of step S1 to step S4 is not limited to the order shown in FIG. 4, and the order to execute the determinations of step S1 to step S4 may be changed arbitrarily or executed simultaneously.

If the opening degree of the side window 5 is equal to or narrower than the predetermined degree α so that the answer of the S4 is YES, the routine progresses to step S5 to execute the control to emit the simulated airstream toward the driver 2. In this situation, specifically, an air volume of the simulated airstream is increased with an increase in the vehicle speed V. For this purpose, the number of revolutions of the blower fan 21 or the fan motor 22 is controlled based on the vehicle speed V. In addition, at step S6, the simulated wind sound is emitted from the speaker 9 in accordance with the air volume of the simulated airstream, and thereafter the routine returns. In this situation, if dust is flying or if there is a bad smell outside the vehicle 1, the external air inlet port 24 shown in FIG. 2 is closed by the switching door 26 and the internal air inlet port 25 is opened so that the air in the vehicle 1 is sent toward the driver 2. In addition, if a temperature of the air circulated in the vehicle 1 is significantly different from a temperature of the external air, the temperature of the air circulated in the vehicle 1 is lowered to the temperature of the external air by activating the refrigeration cycle, or raised to the temperature of the external air by activating the heater core 27. Whereas, if there is no problem with the external air, the external air inlet port 24 is opened to introduce the external air into the vehicle compartment 6 therethrough so that the external air introduced from the external air inlet port 24 is sent to the driver 2.

Thus, according to the exemplary embodiment of present disclosure, the simulated airstream is sent to the driver 2 even in the situation where the vehicle 1 travels in the rain or travels through a site where dust is flying and hence the wind may not be introduced into the vehicle compartment 6 from the side window 5. That is, it is possible to simulate the condition in which the wind enters the vehicle compartment 6 while the vehicle 1 is travelling. Therefore, the driver is allowed to virtually feel the wind while the vehicle 1 is travelling, and in addition, the driver is also allowed to feel the speed of the vehicle 1 by the simulated airstream. Since the driver is thus allowed to feel the driving pleasure, an additional value of the vehicle 1 may be increased. In addition, the simulated airstream may be created in accordance with the vehicle speed V and the opening degree of the side window 5 only by the existing air-conditioning system without requiring extra equipment or components. In other words, the simulated airstream may be created without increasing the size of the system.

Whereas, if the answer of any of the foregoing steps S1 to S4 is NO, the routine progresses to step S7 to inhibit the control to emit the simulated airstream, and thereafter the routine returns. Nonetheless, the air conditioner 7 may also be operated in this case for cooling or heating the vehicle compartment 6.

Although the above exemplary embodiments of the present disclosure have been described, it will be understood by those skilled in the art that the present disclosure should not be limited to the described exemplary embodiments, and various changes and modifications can be made within the scope of the present disclosure. For example, the partition member includes a convertible roof in addition to the side window. Moreover, the simulated airstream may also be created by a dedicated blower instead of the air conditioner. Still moreover, the control system according to the exemplary embodiment of the present disclosure may also be applied to vehicles other than electric vehicles. Further, the simulated wind sound may also be emitted by a reed which emits a sound by the wind passing through at the air outlet instead of the speaker. Furthermore, a switch for selecting an air-conditioning mode may also serve as the above-mentioned the selector switch. In this case, the air-conditioning mode may include the airstream mode. In addition, the traveling determiner may also be configured to determine the propulsion of the vehicle based on a parameter different from the vehicle speed.

What is claimed is:

1. An indoor condition control system for a vehicle, comprising:
a partition member partitioning a vehicle compartment and an external space;
a blower that emits an airstream toward a driver seated in the vehicle compartment; and
a controller that controls a volume of the airstream emitted toward the driver by the blower,
wherein the controller comprises
a travel determiner configured to determine that the vehicle is in travel,
an opening degree determiner configured to determine that an opening degree of the partition member is equal to or narrower than a predetermined degree, and
an airstream controller configured to control the airstream sent to the driver upon satisfaction of a predetermined condition including a fact that the travel determiner determines that the vehicle is in travel, and a fact that the opening degree determiner determines that the opening degree of the partition member is equal to or narrower than the predetermined degree.

2. The indoor condition control system as claimed in claim 1,
wherein the travel determiner includes a vehicle speed detector configured to detect a speed of the vehicle, and
the airstream controller includes an air volume controller configured to increase an air volume of the airstream emitted toward the driver in accordance with the speed of the vehicle detected by the vehicle speed detector.

3. The indoor condition control system as claimed in claim 1, further comprising:
an airstream selector that is operated by the driver to select an airstream mode in which the airstream is emitted toward the driver by the airstream controller.

4. The indoor condition control system as claimed in claim 2, further comprising:
an airstream selector that is operated by the driver to select an airstream mode in which the airstream is emitted toward the driver by the airstream controller.

5. The indoor condition control system as claimed in claim 3,
wherein the blower includes an air conditioner that controls a temperature in the vehicle compartment by sending the air into the vehicle compartment, and
the airstream controller is further configured to emit the airstream toward the driver by the air conditioner when the airstream selector is operated by the driver.

6. The indoor condition control system as claimed in claim 4,
wherein the blower includes an air conditioner that controls a temperature in the vehicle compartment by sending the air into the vehicle compartment, and
the airstream controller is further configured to emit the airstream toward the driver by the air conditioner when the airstream selector is operated by the driver.

7. The indoor condition control system as claimed in claim 1,
wherein the vehicle comprises a motor that serves as a prime mover, and an electric storage device that supplies an electric power to the blower and the motor, and
the controller further comprises
a state of charge level detector configured to detect that a current state of charge level of the electric storage device is equal to or lower than a predetermined level, and
an airstream inhibitor configured to inhibit the emission of the airstream by the airstream controller when the state of charge level of the electric storage device is equal to or lower than the predetermined level.

8. The indoor condition control system as claimed in claim 2,
wherein the vehicle comprises a motor that serves as a prime mover, and an electric storage device that supplies an electric power to the blower and the motor, and
the controller further comprises
a state of charge level detector configured to detect that a current state of charge level of the electric storage device is equal to or lower than a predetermined level, and
an airstream inhibitor configured to inhibit the emission of the airstream by the airstream controller when the state of charge level of the electric storage device is equal to or lower than the predetermined level.

9. The indoor condition control system as claimed in claim 1, wherein the vehicle comprises a simulated sound emitter that emits a simulated sound in accordance with the airstream emitted into the vehicle compartment by the airstream controller.

10. The indoor condition control system as claimed in claim 2, wherein the vehicle comprises a simulated sound emitter that emits a simulated sound in accordance with the airstream emitted into the vehicle compartment by the airstream controller.
